(19) United States
(12) Patent Application Publication
(10) Pub. No.: US 2026/0004482 A1
(43) Pub. Date: Jan. 1, 2026

(54) METHOD, SYSTEM, AND DEVICE FOR ULTRA-LOW-DOSE ORAL CBCT IMAGING

(71) Applicants: CHINA-JAPAN FRIENDSHIP HOSPITAL (CHINA JAPAN FRIENDSHIP CLINICAL MEDICAL RESEARCH INSTITUTE), Beijing (CN); RUISHI WISDOM (BEIJING) MEDICAL TECHNOLOGY CO., LTD, Beijing (CN)

(72) Inventors: Qisheng XIA, Beijing (CN); Hai WANG, Beijing (CN); Yao ZOU, Beijing (CN); Qiang XIONG, Beijing (CN)

(73) Assignees: CHINA-JAPAN FRIENDSHIP HOSPITAL (CHINA JAPAN FRIENDSHIP CLINICAL MEDICAL RESEARCH INSTITUTE), Beijing (CN); RUISHI WISDOM (BEIJING) MEDICAL TECHNOLOGY CO., LTD, Beijing (CN)

(21) Appl. No.: 19/325,574

(22) Filed: Sep. 11, 2025

Related U.S. Application Data
(63) Continuation of application No. PCT/CN2024/119259, filed on Sep. 18, 2024.

(30) Foreign Application Priority Data
Oct. 31, 2023 (CN) 202311424546.5

(51) Int. Cl. G06T 11/00; G06N 3/0464; G06N 3/0475; G06N 3/094; G06T 7/00; G06T 15/20

(52) U.S. Cl. CPC G06T 11/008; G06N 3/0464; G06N 3/0475; G06N 3/094; G06T 7/0012; G06T 15/205; G06T 2207/10081; G06T 2207/20081; G06T 2207/20084; G06T 2207/30036

(57) ABSTRACT

A method, system, and device for ultra-low-dose imaging of oral cone-beam computed tomography (CBCT) are provided. The method encompasses high-dose oral CBCT image data acquisition, data segmentation processing, three-dimensional (3D) reconstruction processing, model training, image data input, image enhancement, and image data output. Specifically, the process involves performing 3D reconstruction on 2D projection data of oral CBCT acquired in ultra-low-dose mode to obtain ultra-low-dose oral CBCT 3D reconstructed image data. This ultra-low-dose oral CBCT 3D reconstructed image data is then input into the oral CBCT ultra-low-dose imaging enhancement network model, from which high-quality oral CBCT image data is output for subsequent clinical diagnosis and treatment processes. This method significantly reduces the radiation dose of imaging while ensuring imaging quality, accelerates imaging speed, and enhances the safety of oral CBCT imaging, holding broad clinical application prospects.

### CROSS REFERENCE TO THE RELATED APPLICATIONS

This application is a continuation application of International Application No. PCT/CN2024/119259, filed on Sep. 18, 2024, which is based upon and claims priority to Chinese Patent Application No. 202311424546.5, filed on Oct. 31, 2023, the entire contents of which are incorporated herein by reference.

### TECHNICAL FIELD

The present invention relates to the field of medical imaging technology, particularly to a method, system, and device for ultra-low-dose oral CBCT (Cone Beam Computed Tomography) imaging.

### BACKGROUND

Oral CBCT is a commonly used oral medical imaging technology, widely applied in the diagnosis and treatment of oral diseases. It obtains two-dimensional projection images by scanning the patient's oral region with a rotating cone-shaped beam of X-rays, and then uses three-dimensional reconstruction techniques to generate high-resolution three-dimensional images of the oral structures from these two-dimensional projection images. Compared to traditional two-dimensional oral X-ray films, oral CBCT provides more precise and comprehensive information about oral structures and lesions, aiding doctors in accurate diagnosis and surgical planning. It plays a crucial role in the diagnosis of oral diseases, surgical planning, and implant surgery navigation.

However, existing oral CBCT imaging technology faces a significant issue: to obtain high-quality reconstructed images, it requires longer X-ray exposure times and higher X-ray radiation doses. This poses considerable health risks to patients, especially for special populations such as children, pregnant women, and particularly in cases requiring multiple repeated imaging, such as planning and intraoperative navigation for oral implant surgeries, where the cumulative effects of radiation can cause non-negligible harm to patients. High-dose radiation has damaging effects on human tissues and organs. Children, young adults, and pregnant women are more sensitive to high-dose radiation. Long-term exposure to high-dose radiation can lead to DNA damage, increasing the risk of cancer. Additionally, high-dose radiation may cause damage and dysfunction to organs such as the throat, thyroid, and salivary glands.

To reduce radiation doses and mitigate potential risks to patients, researchers have been dedicated to developing ultra-low-dose oral CBCT imaging methods that lower radiation doses while maintaining image quality. The research and development of these methods have significant clinical implications for enhancing the safety, accuracy, and reliability of oral medical imaging.

Currently, some common low-dose oral CBCT imaging methods include reconstruction algorithm improvements, image processing techniques, and the use of more advanced imaging sensors. However, these methods have certain limitations. Reconstruction algorithm improvements mainly enhance image resolution and quality by improving back-projection and filtering algorithms, thereby reducing the need for repeated scans and increased doses. Image processing techniques improve image quality through methods such as image denoising, enhancement, and model reconstruction, enabling clear oral CBCT images to be obtained even at low doses. Another common low-dose imaging method is projection parameter optimization, which primarily involves reducing radiation doses by optimizing scanning parameters, such as lowering tube current and/or reducing the number of projection samples (i.e., sparse sampling).

However, these methods often introduce additional computational load and have limited effectiveness; using advanced sensors requires high costs and complex technical equipment; and projection parameter optimization, while reducing doses, often results in loss of image detail and increased noise, leading to decreased image quality and severe artifacts, thereby affecting the accuracy and reliability of clinical diagnoses. Therefore, developing a method that can significantly reduce oral CBCT doses while ensuring image quality is a current research hotspot and challenge.

In recent years, deep learning has made significant progress in the field of medical imaging. By training neural networks, deep learning can learn complex feature representations from large datasets, thereby improving image quality and reducing noise. Particularly, the emergence of Generative Adversarial Networks (GANs) has provided a new approach for image reconstruction and enhancement.

In the research of ultra-low-dose oral CBCT imaging, combining deep learning with sparse sampling techniques is an effective pathway. Sparse sampling is a method to reduce the amount of data collected, significantly lowering the radiation dose of oral CBCT. However, the data quality obtained through sparse sampling is low, with considerable loss of image clarity and details. Therefore, how to use deep learning methods to recover high-quality images from sparse sampling data has become an important direction in the field of ultra-low-dose oral CBCT imaging.

Thus, the present invention proposes a method, system, and device for ultra-low-dose oral CBCT imaging. This method, based on deep learning technology, employs a self-developed Residual Dense Generative Adversarial Network (RDN-GAN) model to enhance the quality of sparsely sampled oral CBCT images. By splitting and reconstructing collected high-dose oral CBCT samples from patients to generate paired image datasets and complete the training of the RDN-GAN model, this model can recover high-quality oral CBCT images from sparse sampling data, significantly reducing the radiation dose to patients and providing more reliable and safer imaging technology for oral medicine.

### SUMMARY

The objective of this invention is to provide a method, system, and device for ultra-low-dose oral CBCT imaging, addressing the issue where existing oral CBCT imaging technologies cannot reduce radiation doses while maintaining imaging quality.

To solve the aforementioned technical problem, the invention adopts the following technical solution:

A method for ultra-low-dose oral CBCT imaging, including:

Image Data Acquisition: Collecting 2D projection data of oral CBCT in high-dose mode from patients.

Image Data Splitting Processing: Splitting the collected 2D projection data of oral CBCT in high-dose mode into paired ultra-sparse sampling projection data and full sampling projection data.

3D Image Data Reconstruction Processing: Performing 3D image data reconstruction on the paired ultra-sparse sampling projection data and full sampling projection data to obtain paired ultra-sparse sampling oral CBCT reconstructed data and full sampling oral CBCT reconstructed datasets.

Model Training: Using the paired ultra-sparse sampling oral CBCT reconstructed data and full sampling oral CBCT reconstructed datasets as training samples to train a residual dense generative adversarial deep learning neural network model, obtaining an oral CBCT ultra-low-dose imaging enhancement network model.

Image Data Input: Performing 3D image data reconstruction on the oral CBCT 2D projection data in ultra-low-dose mode from patients to obtain ultra-low-dose oral CBCT reconstructed data, and inputting it into the oral CBCT ultra-low-dose imaging enhancement network model.

Image Enhancement: The oral CBCT ultra-low-dose imaging enhancement network model enhances the ultra-low-dose oral CBCT reconstructed data to produce high-quality oral CBCT images of the patients.

Image Data Output: Displaying the high-quality oral CBCT images of the patients and outputting the data.

Furthermore, the number of projections in the ultra-sparse sampling projection data ranges from 20 to 60, and the number of projections in the full sampling projection data ranges from 360 to 720. The algorithms used for the 3D image data reconstruction processing include CBCT iterative reconstruction and FDK 3D reconstruction algorithms.

Additionally, the residual dense generative adversarial deep learning neural network model includes a sequentially connected residual dense network and adversarial network. The loss function of the residual dense generative adversarial deep learning neural network model is given by:

$$= arg {min}_{{θ}_{G}} \frac{1}{N} {\sum }_{n = 1}^{N} {1}^{S R} ( {G}_{{θ}_{G}} ( {I}_{n}^{L R} ) , {I}_{n}^{H R} )$$

where N is the total number of training input samples, θ_{G} represents the weights and biases of the residual dense generative adversarial deep learning neural network, n is the index of each training sample, l^{SR} is the perceptual loss function, G_{θ}_{_{G}} is the output of the residual dense network,

$${I}_{n}^{L R}$$

is the input sample of ultra-sparse sampling oral CBCT reconstructed data from the training set,

$${I}_{n}^{H R}$$

is the paired full sampling oral CBCT reconstructed data sample, and [symbol] is the optimal solution of the trained network model.

Moreover, the residual dense network includes convolutional layers, residual dense blocks, concatenation networks, upsampling, and deconvolutional layers. The residual dense blocks are composed of convolutional layers, activation functions, and concatenation layers. The adversarial network is composed of convolutional layers, activation functions, normalization layers, and density networks. The input and output of each density network are given by:

$${F}_{d , c} = σ ( {W}_{d , c} [ {F}_{d - 1} , {F}_{d , 1} , … , {F}_{d , c - 1} ] )$$

where F_{d,c} is the output of the c-th convolutional layer in the d-th density network, F_{d-1} and F_{d} are the input and output of the d-th density network, respectively, σ is the Rectified Linear Unit activation function, W_{d,c} is the weight of each convolutional layer in the density network, [F_{d-1}, F_{d,1}, . . . , F_{d,c-1}] is the concatenated feature map generated by the (d−1)-th density network, F_{d,1} is the output of the first convolutional layer in the d-th density network, and F_{d,c-1} is the output of the (c−1)-th convolutional layer in the d-th density network.

The ReLU activation function is:

$$f ( x ) = max ( 0 , x )$$

The ReLU activation function is a linear function. Compared to activation functions based on Sigmoid or Tanh, ReLU does not suffer from vanishing or exploding gradients during training, leading to a more stable training process. Additionally, the computation of ReLU is simpler, eliminating the need for floating-point operations and significantly reducing processing time.

The concatenation network links the features of all density networks and adaptively controls the output information through a 1×1 convolutional network. Finally, the output of the entire local adversarial density network is obtained through a residual learning network.

Further, to enhance the network's capabilities, features are constructed before the ReLU activation function, and a perceptual loss function is introduced. The calculation formula is as follows:

$${1}^{S R} = {1}_{X}^{S R} + 1 {0}^{- 3} {1}_{G e n}^{S R}$$

Where

$${1}_{X}^{S R}$$

is the content loss function,

$${1}_{G e n}^{S R}$$

is the adversarial loss function,

$${1}_{G e n}^{S R} = {\sum }_{n = 1}^{N} - log {D}_{{θ}_{G}} ( {G}_{{θ}_{G}} ( {I}^{L R} ) )$$

Here, D_{θ}_{_{G}}(G_{θ}_{_{G}}(I^{LR})) represents the probability that the reconstructed image, G_{θ}_{_{G}}(I^{LR}) is a real image, GoG denotes the output of the residual dense network, I^{LR} is the input image to the adversarial network, θ_{G} signifies the weights and biases of the residual dense network, N is the total number of training inputs, and n is the index for each training sample. The values of

$${1}_{X}^{S R}$$

using both the MSE model and the PSNR model are calculated as:

$$PSNR = 20 * {log}_{10} ( {MAX}_{I} ) - 10 * {log}_{10} ( MSE )$$

$$MSE = \frac{1}{m * n} {\sum }_{i = 0}^{m - 1} {\sum }_{j = 0}^{n - 1} {[ I ( i , j ) - K ( i , j ) ]}^{2}$$

Where MAX_{I} is the maximum pixel value. Since the data is normalized during training, this maximum value is l,m,n and represent the horizontal and vertical pixel counts of the input image's resolution, respectively, while i,j are the horizontal and vertical index numbers corresponding to each pixel. I and K denote the enhanced image and the fully sampled image, respectively.

Furthermore, the paired ultra-sparse sampled oral CBCT reconstruction dataset and the fully sampled oral CBCT reconstruction dataset are used as training samples to train the residual dense generative adversarial deep learning neural network model, resulting in an oral CBCT ultra-low-dose imaging enhancement neural network model. This includes:

Data augmentation and normalization are performed on the paired ultra-sparse sampled oral CBCT reconstruction dataset and the fully sampled oral CBCT reconstruction dataset to obtain an image set. The normalized image set is then divided into a training set, a validation set, and a test set.

The training set is used to train the RDN-GAN deep learning network model, the validation set is used to validate the effectiveness of the network model, and the test set is used for further testing of the network model's effectiveness. During the training of the RDN-GAN network model, the Peak Signal-to-Noise Ratio (PSNR) is used as the loss function. On the validation and test sets, the PSNR and Structural Similarity Index (SSIM) of the enhanced images are calculated to evaluate the network model's performance.

The validation and test sets are utilized to validate and test the model. If the validation results do not meet the prediction probability threshold, the generative and adversarial networks are retrained. If the validation results meet the threshold, further testing is conducted using the test set. If the test results meet the prediction probability threshold, the training of the oral CBCT ultra-low-dose imaging enhancement neural network model is completed. If the test results do not meet the threshold, the generative and adversarial networks are retrained.

The present invention also provides a system for oral CBCT ultra-low-dose imaging, including: a projection acquisition module, a 3D reconstruction module, an image enhancement module, and an image display and output module, all connected in sequence; the projection acquisition module is used to collect 2D projection data of oral CBCT in ultra-low-dose mode, the 3D reconstruction module is used to perform 3D reconstruction on the 2D projection data of oral CBCT in ultra-low-dose mode, the image enhancement module is used to input the 2D projection data of oral CBCT in ultra-low-dose mode into the oral CBCT ultra-low-dose imaging enhancement neural network model to obtain enhanced oral CBCT images, and the image display and output module is used to display the enhanced oral CBCT images and output them in Dicom file format.

The present invention further provides a device for oral CBCT ultra-low-dose imaging, including: an oral CBCT imaging component, an image reconstruction component, an image display component, and an image enhancement component; the oral CBCT imaging component is communicatively connected to the image reconstruction component, and the image reconstruction component is communicatively connected to both the image display component and the image enhancement component;

The image reconstruction component is used to perform 3D reconstruction on data acquired by the oral CBCT imaging component; the image enhancement component stores the oral CBCT ultra-low-dose imaging enhancement neural network model and performs image enhancement processing on the 3D data reconstructed by the image reconstruction component; the image display component is used to display the images after image enhancement processing.

Furthermore, the oral CBCT imaging component includes an X-ray tube, a flat-panel detector, a support frame, and a motion platform; the X-ray tube is set on the motion platform and located on one side of the patient, the motion platform is set on the support frame, and the flat-panel detector is set on the other side of the patient and matches the X-ray tube.

Furthermore, the image enhancement component includes a memory, a processor, and a network interface, all electrically connected; the memory stores the oral CBCT ultra-low-dose imaging enhancement neural network model.

Furthermore, the memory includes: phase-change memory, static random-access memory (SRAM), dynamic random-access memory (DRAM), read-only memory (ROM), electrically erasable programmable read-only memory (EEPROM), flash memory, CD-ROM, or DVD-ROM.

Compared with the prior art, the present invention offers the following advantageous technical effects:

The invention discloses a method, system, and device for oral CBCT ultra-low-dose imaging. The imaging method includes image data acquisition, image data splitting processing, image data 3D reconstruction processing, model training, image data input, image enhancement, and image data output. The system includes a projection acquisition module, a 3D reconstruction module, an image enhancement module, and an image display and output module, all connected in sequence. The device includes an oral CBCT imaging component, an image reconstruction component, an image display component, and an image enhancement component.
1) The invention employs a larger amount of high-quality clinical oral CBCT image data for algorithm model training. Specifically, a large-scale clinical dataset (exceeding 1500 cases, with over 200 in high-definition mode) is used for model training. This dataset is one of the largest in the world, significantly enhancing the training effectiveness of the model.
2) An iterative reconstruction algorithm is utilized for 3D reconstruction of 2D projection data. The iterative reconstruction algorithm offers superior reconstruction clarity compared to the traditional FDK reconstruction algorithm. In cases of sparse sampling, it demonstrates higher tolerance, enabling high-definition imaging with fewer samples. However, the main drawbacks of iterative reconstruction algorithms are high computational requirements and long reconstruction times, especially in high-definition mode. In this invention, due to the substantial reduction in sample size, the computational demands and time required for iterative reconstruction are also significantly reduced, achieving a balance between reconstruction time and image quality.
3) The invention adopts an improved deep learning algorithm model based on the Residual Dense Generative Adversarial Network (RDN-GAN) architecture, which has outperformed all existing deep learning algorithms in traditional computer vision fields. After refining and enhancing this algorithm, the invention applies it to the field of oral CBCT imaging enhancement, effectively improving image quality and enhancing image details. Compared to previous CNN-based deep learning image enhancement algorithms, RDN-GAN better preserves spatial resolution, enabling the acquisition of high-quality oral CBCT images even under extreme sparse sampling conditions.
4) The oral CBCT ultra-low-dose imaging method of the invention significantly reduces the radiation dose for patients undergoing oral CBCT examinations, by up to one-twentieth to one-thirtieth of the current dose. It also reduces imaging time and motion-related artifacts while maintaining very high imaging clarity, enhancing the safety of patients, particularly children or those requiring frequent imaging.

### BRIEF DESCRIPTION OF THE DRAWINGS

The present invention is further described below with reference to the accompanying drawings.

FIG. 1 is a flowchart illustrating the steps of the ultra-low-dose imaging method for oral CBCT according to the present invention.

FIG. 2 is a schematic diagram illustrating the principle of oral CBCT image data acquisition according to the present invention.

FIG. 3 is a schematic diagram showing the reconstructed image results without image enhancement for the ultra-low-dose imaging of oral CBCT according to the present invention.

FIG. 4 is a schematic diagram illustrating the principle of the image enhancement network model for ultra-low-dose imaging of oral CBCT according to the present invention.

FIG. 5 is a schematic diagram showing the image enhancement results for the ultra-low-dose imaging of oral CBCT according to the present invention.

FIG. 6 is a system diagram of the ultra-low-dose imaging for oral CBCT according to the present invention.

FIG. 7 is a schematic diagram illustrating the connection relationship of the ultra-low-dose imaging device for oral CBCT according to the present invention.

FIG. 8 is a schematic diagram illustrating the structural principle of the image enhancement module according to the present invention.

Notes to the Drawings: 1. Oral CBCT Imaging Component; 2. Image Reconstruction Component; 3. Image Display Component; 4. Image Enhancement Component; 201. Projection Acquisition Module; 202. Three-Dimensional Reconstruction Module; 203. Image Enhancement Module; 204. Image Display and Output Module; 401. Memory; 402. Processor; 403. Network Interface.

### DETAILED DESCRIPTION OF THE EMBODIMENTS

To make the technical problems, technical solutions, and beneficial effects of the present invention clearer, the following provides a further detailed explanation of the invention with reference to the drawings and embodiments. It should be understood that the specific embodiments described here are only used to explain the invention and are not intended to limit it.

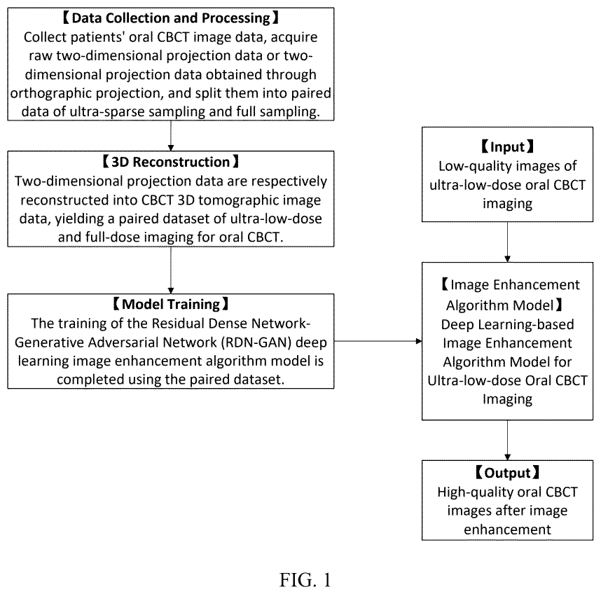

As shown in FIG. 1, a method for ultra-low-dose imaging of oral CBCT includes the following steps:

Image Data Collection: Collect 2D projection data of oral CBCT in high-dose mode from a patient.

Image Data Splitting and Processing: Split the collected 2D projection data of oral CBCT in high-dose mode into paired ultra-sparse sampling data and full sampling data. The ultra-sparse sampling involves collecting 20-60 projections, while the full sampling involves collecting 360-720 projections.

3D Image Reconstruction: Perform 3D image reconstruction on the paired ultra-sparse sampling projection data and full sampling projection data respectively to obtain paired ultra-sparse sampling oral CBCT reconstructed data and full sampling oral CBCT reconstructed datasets.

Model Training: Train a residual dense generative adversarial deep learning neural network model using the paired ultra-sparse sampling oral CBCT reconstructed data and full sampling oral CBCT reconstructed datasets as training samples to obtain an oral CBCT ultra-low-dose imaging image enhancement network model.

Image Data Input: Perform 3D image reconstruction on the oral CBCT 2D projection data in ultra-low-dose mode from a patient to obtain ultra-low-dose oral CBCT reconstructed data, and input it into the oral CBCT ultra-low-dose imaging image enhancement network model.

Image Enhancement: The oral CBCT ultra-low-dose imaging image enhancement network model enhances the ultra-low-dose oral CBCT reconstructed data to obtain high-quality oral CBCT images of the patient.

Image Data Output: Display and output the high-quality oral CBCT images of the patient.

Optionally, if the original 2D projection data is difficult to obtain, multi-angle 2D projection data can also be acquired through forward projection of the oral CBCT full sampling reconstructed data, with projection parameters consistent with the imaging parameters of existing mainstream oral CBCT equipment. In this embodiment, the distance from the X-ray source to the detector is 630 mm, the distance from the X-ray source to the center of the object is 400 mm, the maximum pixel of the flat-panel detector is set to 1920×1536, and the detector pixel height and width are both 0.15 mm.

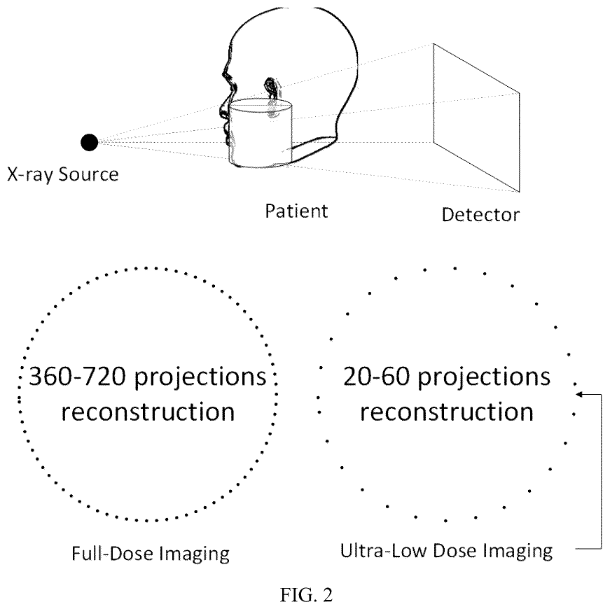

As shown in FIG. 2, the black dots on each circle represent the positions where image projection data is collected. The X-ray source is positioned at the black dots on the circle to irradiate the patient, and the projection image data of the patient is cast onto a flat-panel detector on the other side of the patient. The X-ray tube and flat-panel detector rotate 360 degrees around the imaging area of the human body to capture multi-angle 2D projection data. Full sampling involves collecting 360-720 projections for reconstruction. The method for ultra-low-dose imaging reduces the number of projections collected along the rotational circle, known as sparse sampling, which can significantly decrease scan time and imaging dose. In this invention, sparse sampling involves collecting 20-60 projections, falling into the category of ultra-sparse sampling.

Specifically, the algorithms used for the 3D image reconstruction process include iterative reconstruction algorithms and the FDK 3D reconstruction algorithm. In this embodiment, the CBCT iterative reconstruction algorithm is preferentially used for 3D image reconstruction. The reconstructed image size is 512 pixels×512 pixels, with a pixel size of 0.15 mm×0.15 mm.

As shown in FIG. 3, the three columns of images from left to right are 3D reconstructed images from 10 oral CBCT 2D projection data, 20 oral CBCT 2D projection data, and 60 oral CBCT 2D projection data, respectively. As illustrated in the figure, in the case of sparse sampling, due to the severe lack of sampling information, a large number of artifacts are prone to appear in the CBCT images obtained from 3D reconstruction, leading to a significant decrease in image quality. The higher the degree of sparse sampling, i.e., the fewer the number of projections, the worse the quality of the reconstructed images, affecting the application of oral CBCT images in subsequent clinical diagnosis and treatment.

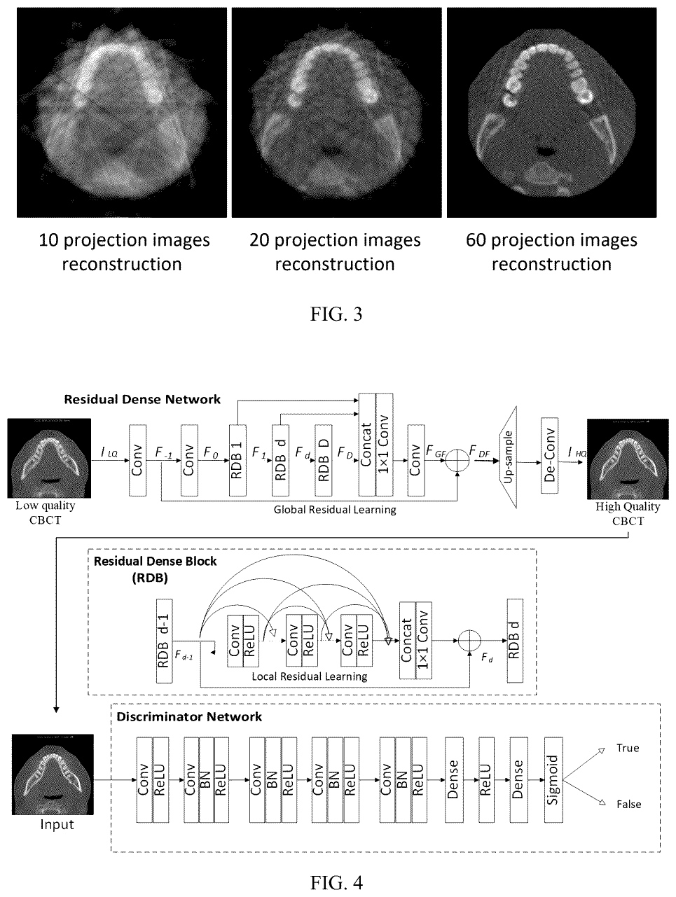

As shown in FIG. 4, this invention employs the Residual Dense Generative Adversarial Network (RDN-GAN) deep learning model as the backbone network for image enhancement in ultra-low-dose oral CBCT imaging. The Residual Dense Generative Adversarial deep learning neural network model includes a Residual Dense Network (RDN) and an Adversarial Network. The RDN includes convolutional layers, residual dense blocks, a concatenation network, upsampling, and deconvolutional layers. The Adversarial Network consists of convolutional layers, activation functions, normalization layers, and a density network. Within this framework, the RDN serves as the generator, where the residual dense blocks consist of multiple convolutional layers, activation functions, concatenation layers, and numerous skip connections, significantly enhancing the network's performance and accuracy. The upsampling layer is used to upsample the low-resolution oral CBCT reconstruction data obtained from sparse sampling. The Adversarial Network acts as a discriminator, tasked with determining whether the enhanced image is a real CBCT image. By processing the input oral CBCT reconstruction data from sparse sampling through multiple residual dense blocks, the image's quality and detail can be progressively improved. Concurrently, the discriminator assesses whether the CBCT images generated by the generator approximate real CBCT images. Through iterative training of the generator and discriminator, the model is continuously optimized, ultimately achieving high-quality image enhancement for CBCT sparse sampling imaging.

In the specific embodiment of this invention, the loss function of the Residual Dense Generative Adversarial deep learning neural network model is as follows:

$$= arg {min}_{{θ}_{G}} \frac{1}{N} {\sum }_{n = 1}^{N} {1}^{S R} ( {G}_{{θ}_{G}} ( {I}_{n}^{L R} ) , {I}_{n}^{H R} )$$

Where N is the total number of training input samples, θ_{G} represents the weights and biases of the Residual Dense Generative Adversarial deep learning neural network, n is the index for each training sample, l^{SR} is the perceptual loss function, which is composed of a weighted combination of multiple loss functions, G_{θ}_{_{G}} represents the output of the Residual Dense Network,

$${I}_{n}^{L R}$$

is the i-th training sample of oral CBCT reconstruction data from sparse sampling,

$${I}_{n}^{H R}$$

is the paired full-sampled CBCT reconstruction data sample, and [symbol] is the optimal solution of the trained network model.

The network aims to train to obtain the optimal solution [symbol] , such that the perceptual loss function between the sparse sampling samples and the full-sampled samples is minimized.

As shown in FIG. 4, in the specific embodiment of this application, the Residual Dense Generative Adversarial deep learning neural network architecture includes a Residual Dense Network (RDN) and an Adversarial Network. The RDN consists of convolutional layers, residual dense blocks, a concatenation network, upsampling, and deconvolutional layers, where each convolutional layer has a kernel size of k×k and c channels. The Adversarial Network, also known as the discriminator, includes convolutional layers, activation functions, normalization layers, and a density network. The discriminator processes input images through convolutional layers with different parameters, normalization layers, and activation functions to ultimately determine whether the image is real or fake.

Specifically, the RDN within the Residual Dense Generative Adversarial deep learning neural network model includes convolutional layers, residual dense blocks, a concatenation network, upsampling, and deconvolutional layers. The residual dense blocks are composed of convolutional layers, activation functions, and concatenation layers. The Adversarial Network includes convolutional layers, activation functions, normalization layers, and a density network.

For the density networks, the input and output of each density network are as follows:

$${F}_{d , c} = σ ( {W}_{d , c} [ {F}_{d - 1} , {F}_{d , 1} , … , {F}_{d , c - 1} ] )$$

Where F_{d,c} represents the output of the c-th convolutional layer in the d-th density network, F_{d-1} and F_{d} are the input and output of the d-th density network, respectively, a denotes the Rectified Linear Unit activation function, W_{d,c} is the weight of the c-th convolutional layer in the d-th density network, [F_{d-1}, F_{d,1}, . . . , F_{d,c-1}] is the concatenated feature map generated by the (d−1)-th density network, F_{d,1} is the output of the first convolutional layer in the d-th density network, and F_{d,c-1} is the output of the (c−1)-th convolutional layer in the d-th density network.

The ReLU activation function is defined as:

$$f ( x ) = max ( 0 , x )$$

The ReLU activation function is a linear function. Compared to traditional activation functions like Sigmoid or Tanh, during training, the ReLU activation function does not suffer from vanishing or exploding gradients, which makes the entire training process more stable. Additionally, the computation of the ReLU activation function is simpler, eliminating the need for floating-point operations and significantly reducing processing time.

The concatenation network links features from all density networks and adaptively controls the output information through a 1×1 convolutional network. Finally, the output of the entire local adversarial density network is obtained through a residual learning network.

Specifically, to further enhance the network's capabilities, features are constructed before the ReLU activation function, and a perceptual loss function l^{SR} is introduced. Its calculation formula is:

$${l}^{S R} = {l}_{x}^{S R} + 1 {0}^{- 3} {l}_{G e n}^{S R}$$

where

$${l}_{x}^{SR}$$

is the content loss function, l_{Gen}^{SR} is the adversarial loss function,

$${l}_{G e n}^{SR} = {\sum }_{n = 1}^{N} - log {D}_{{θ}_{G}} ( {G}_{{0}_{G}} ( {I}^{L R} ) )$$

Here, D_{θ}_{_{G}}(G_{θ}_{_{G}}(I^{LR})) represents the probability that the reconstructed image, G_{θ}_{_{G}}(I^{LR}) is a real image, G_{θ}_{_{G}} is the output of the Residual Dense Network, I^{LR} is the input image to the Adversarial Network, θ_{G} represents the weights and biases of the Residual Dense Network, N is the total number of training inputs, n is the index for each training sample, MSE model and PSNR are used to calculate the value of

$${l}_{X}^{SR}$$

$$P S N R = 20 * {log}_{10} ( M A {X}_{I} ) - 10 * {log}_{10} ( M SE )$$

$$MSE = \frac{1}{m * n} {\sum }_{i = 0}^{m - 1} {\sum }_{j = 0}^{n - 1} {[ I ( i , j ) - K ( i , j ) ]}^{2}$$

where MAX_{I} is the maximum pixel value. Since the data is normalized during training, this maximum value is l,m,n represent the horizontal and vertical pixel counts of the input image's resolution, respectively, and i,j are the corresponding horizontal and vertical index numbers for each pixel. I and K represent the enhanced image and the fully sampled image, respectively.

Further, in a specific embodiment, the model training includes:

Performing linear interpolation and affine transformation on the paired ultra-sparse sampled oral CBCT reconstruction data and fully sampled oral CBCT reconstruction data to normalize the images to 512-pixel×512-pixel size, followed by data augmentation and normalization. The normalized image set is then divided into a training set, a validation set, and a test set.

Specifically, the training set is used to train the RDN-GAN deep learning network model, the validation set is used to validate the effectiveness of the network model, and the test set is used for further testing of the network model's performance. During the training process of the RDN-GAN network model, the Peak Signal-to-Noise Ratio (PSNR) is adopted as the loss function, and the Adam algorithm is used for optimization. During training, the training set data is randomly divided into small batches for training, with a total of 5000 training epochs. On the validation set and test set, the Peak Signal-to-Noise Ratio (PSNR) and Structural Similarity Index (SSIM) of the enhanced images are calculated to evaluate the effectiveness of the network model.

Using the validation set and test set to validate and test the model, if the validation results do not meet the prediction probability threshold, the generator network and discriminator network are retrained. If the validation results meet the prediction probability threshold, further testing is conducted using the test set. If the test results meet the prediction probability threshold, the training of the oral CBCT ultra-low-dose imaging enhancement network model is completed. If the test results do not meet the prediction probability threshold, the generator network and discriminator network are retrained.

Since all deep learning algorithm models require training, the quality and quantity of training data can affect the final model training performance. To achieve good results, as a specific embodiment, the training data details for the oral CBCT ultra-low-dose imaging enhancement model in this invention are as follows: It includes high-dose CBCT image data from more than 1,500 patients, with over 200 cases in high-resolution imaging mode. The imaging devices used are Newtom, Sirona, and Soredex. Each patient has approximately 200 to 500 tomographic images, with a pixel size of 0.1-0.3 mm, a projection rotation angle of 360 degrees, ultra-sparse sampling of 20, 30, or 60 projections for reconstruction, and full sampling reconstruction of 360 or 600 projections.

After training is completed, only the testing program and the trained model need to be retained for all modules. Moreover, in implementation, fixed-point implementation is adopted to avoid floating-point operations, significantly speeding up the overall system's operation.

It should be additionally noted that the pre-trained oral CBCT ultra-low-dose imaging enhancement network model in this invention can be directly applied to the enhancement process of oral CBCT ultra-low-dose images from various devices. In some cases, such as when the enhanced image quality is insufficient or there is significant distortion, the model can be further optimized by adding additional oral CBCT data for training, especially data from the current oral CBCT device source, to improve the robustness and accuracy of the algorithm model.

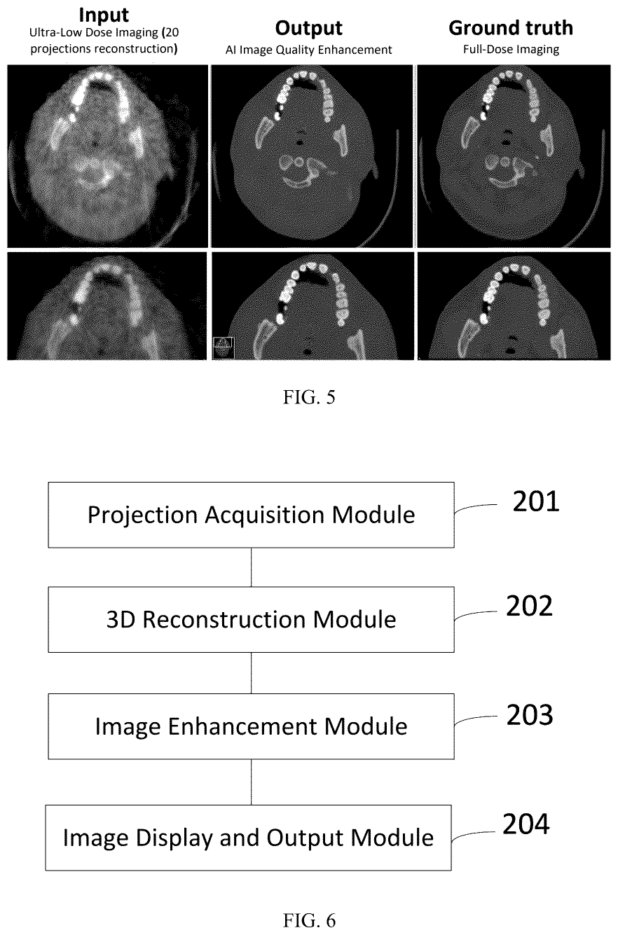

FIG. 5 presents the results of oral CBCT ultra-low-dose imaging enhancement according to an embodiment of the present invention. The first column shows the low-quality CBCT reconstructed images from ultra-low-dose oral CBCT imaging with 20 projections sampled. The second column displays the enhanced images output by the embodiment of the present invention. The third column showcases the high-dose (fully sampled) CBCT reconstructed images (Ground truth), serving as the standard for assessing the clarity and fidelity of the enhanced images.

As evident from the results in FIG. 5, applying the method of the present invention for CBCT image enhancement effectively eliminates artifacts caused by extreme sparse sampling, significantly improving image quality and details with high clarity and low distortion. The PSNR value of the enhanced images increased from 7.84 dB to 11.78 dB, and the SSIM value improved from 0.34 to 0.42. Compared with existing technologies, our method maintains high imaging quality and resolution while reducing radiation dose by 95%. These results demonstrate that our method can effectively enhance the quality and details of oral CBCT ultra-low-dose images, providing a new solution for low-dose high-definition oral CBCT imaging with excellent application prospects in the field of oral CBCT imaging.

It should be noted that in ultra-low-dose sparse sampling oral CBCT imaging, as the sparsity increases, i.e., the number of projections decreases, more and more severe artifacts will appear in the reconstructed images, making it more challenging for the algorithm model to achieve image enhancement. After extensive experimentation, exploration, and model optimization, the present invention has successfully enhanced 20-projection reconstructed images of oral CBCT. Based on numerous experiments, it has been found that 20-projection reconstruction is nearly the limit of our ultra-low-dose oral CBCT imaging method. Achieving high-precision image enhancement under such extreme sparse sampling conditions is already at the world-leading level. Further reducing the number of samples would result in distortion in the enhanced images. Of course, it is possible that more advanced algorithms and higher-quality datasets in the future could enable high-definition reconstruction of oral CBCT with even fewer samples.

The hardware platform relied upon by the pre-constructed oral CBCT ultra-low-dose imaging enhancement method of the present invention is Nvidia's GPU. On Nvidia's 4090 GPU hardware, the deep learning algorithm of the present invention can process at least 10 frames of images per second. In summary, the present invention combines computer vision technology with the latest artificial intelligence deep learning technology to achieve image quality enhancement of post-sparse-sampling reconstruction, ensuring clear patient imaging while significantly reducing patient radiation dose. Overall, the present invention boasts more accurate algorithms, stronger robustness, the ability to handle more extreme situations, and the effectiveness in eliminating noise caused by various external imaging interferences.

In conclusion, addressing the limitation of high radiation dose in existing oral CBCT imaging, the present invention provides a deep learning-based method for enhancing oral CBCT ultra-low-dose imaging. By utilizing the latest and more advanced Residual Dense Generative Adversarial Network (RDN-GAN) deep learning neural network model for image enhancement and applying a CBCT iterative reconstruction algorithm for three-dimensional reconstruction of two-dimensional projection data, high-definition imaging can be achieved with a lower number of samples. As shown in FIG. 5, the invention demonstrates excellent image enhancement effects. In the embodiments of the present invention, the algorithm model efficiently eliminates artifacts caused by sparse sampling, significantly improves image quality, enhances image details, and maintains high image fidelity. Therefore, the present invention can substantially reduce patient radiation dose while maintaining high imaging clarity, accelerating imaging speed, enhancing patient safety during examinations, and reducing motion-related artifacts. It offers a new solution for low-dose high-definition oral CBCT imaging, with promising applications in oral disease diagnosis, surgical planning, and implant surgery navigation.

As shown in FIG. 6, this embodiment also provides a system for the aforementioned ultra-low-dose oral CBCT imaging, including a projection acquisition module 201, a three-dimensional reconstruction module 202, an image enhancement module 203, and an image display and output module 204, which are connected in sequence.

The projection acquisition module 201 is used to collect two-dimensional projection data of oral CBCT in the ultra-low-dose mode from patients.

The three-dimensional reconstruction module 202 is used to perform three-dimensional reconstruction on the two-dimensional projection data of oral CBCT in the ultra-low-dose mode.

The image enhancement module 203 is used to input the two-dimensional projection data of oral CBCT in the ultra-low-dose mode into the trained ultra-low-dose oral CBCT image enhancement network model to obtain enhanced oral CBCT images.

The image display and output module 204 is used to display the enhanced oral CBCT images and output them in Dicom file format.

After training is completed, only the testing program and the trained model need to be retained for all modules. During specific image acquisition and subsequent processing for patients, floating-point numbers are converted to fixed-point numbers to avoid floating-point operations, thereby improving the overall system's operating speed.

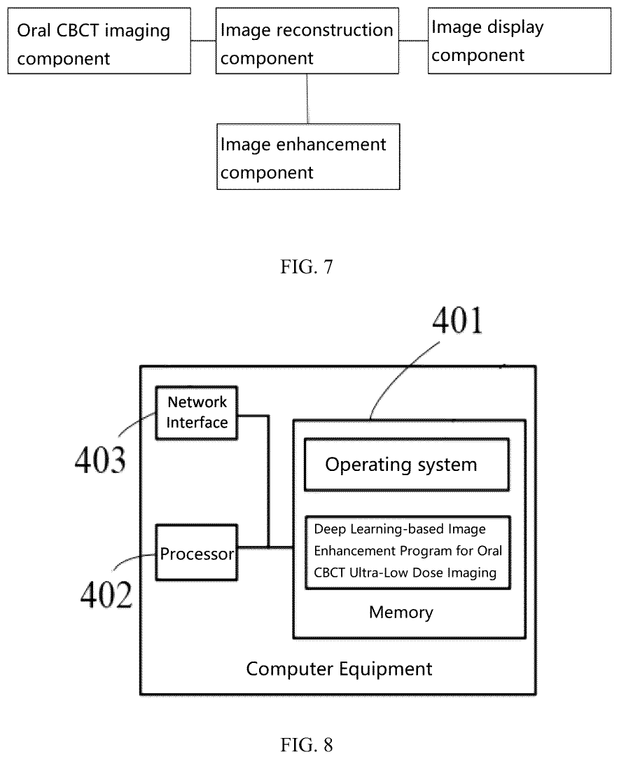

As shown in FIG. 7, this embodiment also provides a device for the aforementioned ultra-low-dose oral CBCT imaging, including: an oral CBCT imaging component 1, an image reconstruction component 2, an image display component 3, and an image enhancement component 4; the oral CBCT imaging component 1 is communicatively connected to the image reconstruction component 2, and the image reconstruction component 2 is communicatively connected to both the image display component 3 and the image enhancement component 4.

The image reconstruction component 2 is used to perform three-dimensional reconstruction of the data acquired by the oral CBCT imaging component 1; the image enhancement component 4 stores an ultra-low-dose oral CBCT image enhancement network model and performs image enhancement processing on the three-dimensional data reconstructed by the image reconstruction component 2; the image display component 3 is used to display the images after image enhancement processing.

Specifically, the oral CBCT imaging component 1 includes an X-ray tube, a flat-panel detector, a support frame, and a motion platform. The X-ray tube is set on the motion platform and located on one side of the patient. The motion platform is set on the support frame, and the flat-panel detector is set on the other side of the patient and matches the X-ray tube.

As shown in FIG. 8, the image enhancement component 4 includes a memory 401, a processor 402, and a network interface 403, which are electrically connected; the memory 401 stores the ultra-low-dose oral CBCT image enhancement network model. FIG. 8 is merely a block diagram of part of the structure related to the solution of this application and does not constitute a limitation on the computer device on which the solution of this application is applied. The specific computer device may include more or fewer components than shown in the figure, or combine certain components, or have a different component arrangement.

This embodiment also provides a storage device for the aforementioned ultra-low-dose oral CBCT imaging, including: Phase-change RAM (PRAM), Static RAM (SRAM), Dynamic RAM (DRAM), Read-Only Memory (ROM), Electrically Erasable Programmable ROM (EEPROM), Flash Memory, CD-ROM, or Digital Versatile Disc (DVD).

It should be noted that in this document, relational terms such as “first” and “second” are merely used to distinguish one entity or operation from another entity or operation, and do not necessarily require or imply any actual relationship or order between these entities or operations. Moreover, the terms “comprise,” “include,” or any other variants are intended to encompass non-exclusive inclusion, such that a process, method, article, or device that includes a series of elements not only includes those elements but also includes other elements that are not explicitly listed, or elements that are inherent to such a process, method, article, or device.

The embodiments described above are merely descriptions of preferred ways to implement the invention and do not limit the scope of the invention. Without departing from the design spirit of the invention, various modifications and improvements made to the technical solutions of the invention by ordinary technicians in the field should fall within the protection scope defined by the claims of the invention.

What is claimed is:

1. A method for ultra-low-dose imaging of oral cone-beam computed tomography (CBCT), comprising:
image data acquisition: collecting two-dimensional (2D) projection data of the oral CBCT in a high-dose mode from a patient;
image data splitting processing: splitting the 2D projection data of the oral CBCT in the high-dose mode into paired ultra-sparse sampling projection data and full sampling projection data;
three-dimensional (3D) image reconstruction: performing 3D reconstruction on the paired ultra-sparse sampling projection data and full sampling projection data respectively to obtain paired ultra-sparse sampling oral CBCT reconstructed data and full sampling oral CBCT reconstructed data sets;
model training: training a residual dense generative adversarial deep learning neural network model using the paired ultra-sparse sampling oral CBCT reconstructed data and full sampling oral CBCT reconstructed data sets as training samples to obtain an oral CBCT ultra-low-dose imaging enhancement network model;
image data input: performing 3D image reconstruction on 2D projection data of the oral CBCT in an ultra-low-dose mode from the patient to obtain ultra-low-dose oral CBCT reconstructed data, and inputting the ultra-low-dose oral CBCT reconstructed data into the oral CBCT ultra-low-dose imaging enhancement network model;
image enhancement: processing the ultra-low-dose oral CBCT reconstructed data with the oral CBCT ultra-low-dose imaging enhancement network model to obtain high-quality oral CBCT images of the patient;
image data output: displaying the high-quality oral CBCT images of the patient and outputting image data.

2. The method for ultra-low-dose imaging of the oral CBCT according to claim 1, wherein a number of projections in the ultra-sparse sampling projection data ranges from 20 to 60 projections, and a number of projections in the full sampling projection data ranges from 360 to 720 projections;
an algorithm configured for the 3D image reconstruction comprises a CBCT iterative reconstruction algorithm and an FDK 3D reconstruction algorithm.

3. The method for ultra-low-dose imaging of the oral CBCT according to claim 1, wherein the residual dense generative adversarial deep learning neural network model comprises a residual dense network and an adversarial network connected in sequence, and a loss function of the residual dense generative adversarial deep learning neural network model is:
$$= arg {min}_{{θ}_{G}} \frac{1}{N} {\sum }_{n = 1}^{N} {l}^{SR} ( {G}_{{θ}_{G}} ( {I}_{n}^{LR} ) , {I}_{n}^{HR} )$$
wherein N is a total number of training input samples, θ_{G} represents weights and biases of the residual dense generative adversarial deep learning neural network, n is an index of each training sample, l^{SR} is a perceptual loss function, G_{θ}_{_{G}} represents an output of the residual dense network, Iₙ^{LR} is an ultra-sparse sampling oral CBCT reconstructed data input sample from a training set, Iₙ^{HR} is a paired full sampling oral CBCT reconstructed data sample from the training set, and [symbol] is an optimal solution of the oral CBCT ultra-low-dose imaging enhancement network model.

4. The method for ultra-low-dose imaging of the oral CBCT according to claim 3, wherein the residual dense network comprises a convolutional layer, a residual dense block, a concatenation network, an upsampling layer, and a deconvolutional layer, and the residual dense block is composed of a convolutional layer, an activation function, and a concatenation layer;
the adversarial network is composed of a convolutional layer, an activation function, a normalization layer, and a density network, and input and output of each density network are:
$${F}_{d , c} = σ ( {W}_{d , c} [ {F}_{d - 1} , {F}_{d , 1} , … , {F}_{d , c - 1} ] )$$
wherein F_{d,c} is an output of a c-th convolutional layer in a d-th density network, F_{d-1} and F_{d} are input and output of the d-th density network, respectively, σ is an ReLU activation function, W_{d,c} is a weight of each convolutional layer in the density network, and [F_{d-1}, F_{d,1}, . . . , F_{d,c-1}] is a concatenated feature map generated by a (d−1)-th density network; F_{d,1} is an output of a first convolutional layer in the d-th density network, and F_{d,c-1} is an output of a (c−1)-th convolutional layer in the d-th density network.

5. The method for ultra-low-dose imaging of the oral CBCT according to claim 4, wherein before the ReLU activation function, features are constructed and the perceptual loss function l^{SR} is introduced, with a calculation formula being:
$${l}^{SR} = {l}_{X}^{SR} + 1 {0}^{- 3} {l}_{G e n}^{SR}$$
wherein [symbol] is a content loss function, [symbol] is an adversarial loss function,
$${l}_{G e n}^{SR} = {\sum }_{n = 1}^{N} - log {D}_{{θ}_{G}} ( {G}_{{θ}_{G}} ( {I}^{LR} ) )$$
wherein D_{θ}_{_{G}}(G_{θ}_{_{G}}(I^{LR})) denotes a reconstructed image, G_{θ}_{_{G}}(I^{LR}) represents a probability of a real image, G_{θ}_{_{G}} denotes the output of the residual dense network, I^{LR} represents an input image to the adversarial network, θ_{G} represents the weights and biases of the residual dense generative adversarial deep learning neural network, N is the total number of the training input samples, and n is the index for each training sample, values of [symbol] are calculated using MSE and PSNR as follows:
$$P S N R = 20 * {log}_{10} ( M A {X}_{I} ) - 10 * {log}_{10} ( M SE )$$
$$MSE = \frac{1}{m * n} {\sum }_{i = 0}^{m - 1} {\sum }_{j = 0}^{n - 1} {[ I ( i , j ) - K ( i , j ) ]}^{2}$$
wherein MAX_{I} is a maximum pixel value, since data is normalized during a training process, the maximum pixel value is l,m,n represent horizontal and vertical pixel counts of an input image resolution, respectively, while i,j are horizontal and vertical index numbers corresponding to each pixel, I and K represent an enhanced image and a fully sampled image, respectively.

6. A system for applying the method for ultra-low-dose imaging of the oral CBCT according to claim 1, comprising: a projection acquisition module, a three-dimensional reconstruction module, an image enhancement module, and an image display and output module connected in sequence; wherein the projection acquisition module is configured to collect two-dimensional projection data of the oral CBCT in the ultra-low-dose mode from the patient, the three-dimensional reconstruction module is configured to perform three-dimensional reconstruction on the two-dimensional projection data of the oral CBCT in the ultra-low-dose mode, the image enhancement module is configured to input the two-dimensional projection data of the oral CBCT in the ultra-low-dose mode into the oral CBCT ultra-low-dose imaging enhancement network model to obtain enhanced oral CBCT images, and the image display and output module is configured to display the enhanced oral CBCT images and output the enhanced oral CBCT images in Dicom file format.

7. A device for applying the method for ultra-low-dose imaging of the oral CBCT according to claim 1, comprising: an oral CBCT imaging component, an image reconstruction component, an image display component, and an image enhancement component; wherein the oral CBCT imaging component is communicatively connected to the image reconstruction component, and the image reconstruction component is communicatively connected to both the image display component and the image enhancement component; the image reconstruction component is configured to perform three-dimensional reconstruction on data acquired by the oral CBCT imaging component; the image enhancement component stores the oral CBCT ultra-low-dose imaging enhancement network model and performs image enhancement processing on three-dimensional data reconstructed by the image reconstruction component, and the image display component is configured to display images after image enhancement processing.

8. The device according to claim 7, wherein the oral CBCT imaging component comprises an X-ray tube, a flat-panel detector, a support frame, and a motion platform, wherein the X-ray tube is set on the motion platform and located on a first side of the patient, the motion platform is set on the support frame, and the flat-panel detector is set on a second side of the patient and matches the X-ray tube.

9. The device according to claim 7, wherein the image enhancement component comprises a memory, a processor, and a network interface, wherein the memory, the processor, and the network interface are electrically connected; the memory stores the oral CBCT ultra-low-dose imaging enhancement network model.

10. The device according to claim 9, wherein the memory comprises phase-change memory, static random-access memory, dynamic random-access memory, read-only memory, electrically erasable programmable read-only memory, flash memory, CD-ROM, or DVD.

11. The system according to claim 6, wherein in the method for ultra-low-dose imaging of the oral CBCT, a number of projections in the ultra-sparse sampling projection data ranges from 20 to 60 projections, and a number of projections in the full sampling projection data ranges from 360 to 720 projections;
an algorithm configured for the 3D image reconstruction comprises a CBCT iterative reconstruction algorithm and an FDK 3D reconstruction algorithm.

12. The system according to claim 6, wherein in the method for ultra-low-dose imaging of the oral CBCT, the residual dense generative adversarial deep learning neural network model comprises a residual dense network and an adversarial network connected in sequence, and a loss function of the residual dense generative adversarial deep learning neural network model is:
$$= arg {min}_{{θ}_{G}} \frac{1}{N} {\sum }_{n = 1}^{N} {l}^{SR} ( {G}_{{θ}_{G}} ( {I}_{n}^{LR} ) , {I}_{n}^{HR} )$$
wherein N is a total number of training input samples, θ_{G} represents weights and biases of the residual dense generative adversarial deep learning neural network, n is an index of each training sample, l^{SR} is a perceptual loss function, G_{θ}_{_{G}} represents an output of the residual dense network,
$${I}_{n}^{L R}$$
is an ultra-sparse sampling oral CBCT reconstructed data input sample from a training set,
$${I}_{n}^{HR}$$
is a paired full sampling oral CBCT reconstructed data sample from the training set, and [symbol] is an optimal solution of the oral CBCT ultra-low-dose imaging enhancement network model.

13. The system according to claim 12, wherein in the method for ultra-low-dose imaging of the oral CBCT, the residual dense network comprises a convolutional layer, a residual dense block, a concatenation network, an upsampling layer, and a deconvolutional layer, and the residual dense block is composed of a convolutional layer, an activation function, and a concatenation layer;
the adversarial network is composed of a convolutional layer, an activation function, a normalization layer, and a density network, and input and output of each density network are:
$${F}_{d , c} = σ ( {W}_{d , c} [ {F}_{d - 1} , {F}_{d , 1} , … , {F}_{d , c - 1} ] )$$
wherein F_{d,c} is an output of a c-th convolutional layer in a d-th density network, F_{d-1} and F_{d} are input and output of the d-th density network, respectively, σ is an ReLU activation function, W_{d,c} is a weight of each convolutional layer in the density network, and [F_{d-1}, F_{d,1}, . . . , F_{d,c-1}] is a concatenated feature map generated by a (d−1)-th density network; F_{d,1} is an output of—a first convolutional layer in the d-th density network, and F_{d,c-1} is an output of a (c−1)-th convolutional layer in the d-th density network.

14. The system according to claim 13, wherein in the method for ultra-low-dose imaging of the oral CBCT, before the ReLU activation function, features are constructed and the perceptual loss function l^{SR} is introduced, with a calculation formula being:
$${l}^{SR} = {l}_{X}^{SR} + {10}^{- 3} {l}_{G e n}^{SR}$$
wherein
$${1}_{X}^{S R}$$
is a content loss function,
$${1}_{G e n}^{S R}$$
is an adversarial loss function,
$${1}_{G e n}^{S R} = {\sum }_{n = 1}^{N} - log {D}_{{θ}_{G}} ( {G}_{{θ}_{G}} ( {I}^{L R} ) )$$
wherein D_{θ}_{_{G}}(G_{θ}_{_{G}}(I^{LR})) denotes a reconstructed image, G_{θ}_{_{G}}(I^{LR}) represents a probability of a real image, G_{θ}_{_{G}} denotes the output of the residual dense network, I^{LR} represents an input image to the adversarial network, θ_{G} represents the weights and biases of the residual dense generative adversarial deep learning neural network, N is the total number of the training input samples, and n is the index for each training sample, values of
$${1}_{X}^{S R}$$
are calculated using MSE and PSNR as follows:
$$P S N R = 20 * {log}_{10} ( M A {X}_{I} ) - 10 * {log}_{10} ( MSE )$$
$$MSE = \frac{1}{m * n} {\sum }_{i = 0}^{m - 1} {\sum }_{j = 0}^{n - 1} {[ I ( i , j ) - K ( i , j ) ]}^{2}$$
wherein MAX_{I} is a maximum pixel value, since data is normalized during a training process, the maximum pixel value is l,m,n represent horizontal and vertical pixel counts of an input image resolution, respectively, while i,j are horizontal and vertical index numbers corresponding to each pixel, I and K represent an enhanced image and a fully sampled image, respectively.

15. The device according to claim 7, wherein in the method for ultra-low-dose imaging of the oral CBCT, a number of projections in the ultra-sparse sampling projection data ranges from 20 to 60 projections, and a number of projections in the full sampling projection data ranges from 360 to 720 projections;
an algorithm configured for the 3D image reconstruction comprises a CBCT iterative reconstruction algorithm and an FDK 3D reconstruction algorithm.

16. The device according to claim 7, wherein in the method for ultra-low-dose imaging of the oral CBCT, the residual dense generative adversarial deep learning neural network model comprises a residual dense network and an adversarial network connected in sequence, and a loss function of the residual dense generative adversarial deep learning neural network model is:
$$= arg {min}_{{θ}_{G}} \frac{1}{N} {\sum }_{n = 1}^{N} {1}^{S R} ( {G}_{{θ}_{G}} ( {I}_{n}^{L R} ) , {I}_{n}^{H R} )$$
wherein N is a total number of training input samples, θ_{G} represents weights and biases of the residual dense generative adversarial deep learning neural network, n is an index of each training sample, l^{SR} is a perceptual loss function, G_{θ}_{_{G}} represents an output of the residual dense network,
$${I}_{n}^{L R}$$
is an ultra-sparse sampling oral CBCT reconstructed data input sample from a training set,
$${I}_{n}^{H R}$$
is a paired full sampling oral CBCT reconstructed data sample from the training set, and [symbol] is an optimal solution of the oral CBCT ultra-low-dose imaging enhancement network model.

17. The device according to claim 16, wherein in the method for ultra-low-dose imaging of the oral CBCT, the residual dense network comprises a convolutional layer, a residual dense block, a concatenation network, an upsampling layer, and a deconvolutional layer, and the residual dense block is composed of a convolutional layer, an activation function, and a concatenation layer;
the adversarial network is composed of a convolutional layer, an activation function, a normalization layer, and a density network, and input and output of each density network are:
$${F}_{d , c} = σ ( {W}_{d , c} [ {F}_{d - 1} , {F}_{d , 1} , … , {F}_{d , c - 1} ] )$$
wherein F_{d,c} is an output of a c-th convolutional layer in a d-th density network, F_{d-1} and F_{d} are input and output of the d-th density network, respectively, σ is an ReLU activation function, W_{d,c} is a weight of each convolutional layer in the density network, and [F_{d-1}, F_{d,1}, . . . , F_{d,c-1}] is a concatenated feature map generated by a (d−1)-th density network; F_{d,1} is an output of—a first convolutional layer in the d-th density network, and F_{d,c-1} is an output of a (c−1)-th convolutional layer in the d-th density network.

18. The device according to claim 17, wherein in the method for ultra-low-dose imaging of the oral CBCT, before the ReLU activation function, features are constructed and the perceptual loss function l^{SR} is introduced, with a calculation formula being:
$${1}^{S R} = {1}_{X}^{S R} + 1 {0}^{- 3} {1}_{G e n}^{S R}$$
wherein
$${1}_{X}^{S R}$$
is a content loss function,
$${1}_{G e n}^{S R}$$
is an adversarial loss function,
$${1}_{G e n}^{S R} = {\sum }_{n = 1}^{N} - log {D}_{{θ}_{G}} ( {G}_{{θ}_{G}} ( {I}^{L R} ) )$$
wherein DOG (G_{θ}_{_{G}} (LR)) denotes a reconstructed image, G_{θ}_{_{G}}(I^{LR}) represents a probability of a real image, G_{θ}_{_{G}} denotes the output of the residual dense network, I^{LR} represents an input image to the adversarial network, θ_{G} represents the weights and biases of the residual dense generative adversarial deep learning neural network, N is the total number of the training input samples, and n is the index for each training sample, values of
$${1}_{X}^{S R}$$
are calculated using MSE and PSNR as follows:
$$PSNR = 20 * {log}_{10} ( M A {X}_{I} ) - 10 * {log}_{10} ( MSE )$$
$$MSE = \frac{1}{m * n} {\sum }_{i = 0}^{m - 1} {\sum }_{j = 0}^{n - 1} {[ I ( i , j ) - K ( i , j ) ]}^{2}$$
wherein MAX_{I} is a maximum pixel value, since data is normalized during a training process, the maximum pixel value is l,m,n represent horizontal and vertical pixel counts of an input image resolution, respectively, while i,j are horizontal and vertical index numbers corresponding to each pixel, I and K represent an enhanced image and a fully sampled image, respectively.

19. The device according to claim 15, wherein the oral CBCT imaging component comprises an X-ray tube, a flat-panel detector, a support frame, and a motion platform, wherein the X-ray tube is set on the motion platform and located on a first side of the patient, the motion platform is set on the support frame, and the flat-panel detector is set on a second side of the patient and matches the X-ray tube.

20. The device according to claim 16, wherein the oral CBCT imaging component comprises an X-ray tube, a flat-panel detector, a support frame, and a motion platform, wherein the X-ray tube is set on the motion platform and located on a first side of the patient, the motion platform is set on the support frame, and the flat-panel detector is set on a second side of the patient and matches the X-ray tube.
